(19) United States
(12) Patent Application Publication
(10) Pub. No.: US 2010/0096239 A1
(43) Pub. Date: Apr. 22, 2010

(54) Coin Hopper Conversion Method And Apparatus

(76) Inventor: Anthony R. Russo, Merrick, NY (US)

Correspondence Address: Island Patent, 12 Rutgers Road, Farmingville, NY, 11738, US

(21) Appl. No.: 12/254,068

(22) Filed: Oct. 20, 2008

(51) Int. Cl. G07F 7/04; G07F 9/00

(52) U.S. Cl. 194/206; 194/216

(57) ABSTRACT

Methods and apparatus provide a modular solution for converting a coin-based payout gaming machine into a paper-based payout gaming machine. The method calls for removing a conventional coin hopper mechanism and replacing it with a coin hopper conversion apparatus. The coin hopper conversion apparatus includes a coin hopper conversion module and a printer module. The coin hopper conversion module is interfaced to the gaming machine using an unmodified interface, often using the original gaming machine connector, which was previously employed for interfacing to the coin hopper mechanism. The printer module is included and operatively coupled to the coin hopper conversion module for printing and dispensing paper-based payouts in the form of redeemable cashier receipts. This abstract is provided to comply with rules requiring an abstract, and is submitted with the intention that it will not be used to interpret or limit the scope and meaning of the claims.

### TECHNICAL FIELD

The presently disclosed invention relates most generally to gaming machines. More particularly, the present invention relates to a coin hopper conversion method and apparatus, wherein with minimal modification and in a truly modular fashion, a coin-based payout gaming machine may be rapidly and readily converted to a paper-based payout machine.

### BACKGROUND

Many legacy gaming machines are designed to accept paper money, such as $5, $10, and $20 bills when a player wants to start playing at a machine. The bills are simply inserted into a slot, and a bill reading and scanning device receives and verifies the bill. Once the bill is scanned and verified, the gaming machine provides an appropriate number of credits and playing may commence. At some subsequent time, when the player wants to stop playing at what will be termed a legacy (coin-payout) machine, the player must “cash out.” At that point such legacy gaming machines will count out and dispense the correct number of coins or tokens that are required to provide the player with the total payout amount. In contrast, many newer state-of-the-art gaming machines now accept bills for input, and provide for ‘coinless’ paper payout, typically by printing a redeemable cashier receipt. Cashier receipts are redeemable at casino cashier windows, and some locations provide automated scanning/payout machines for cashier receipts.

It should be noted that many of the legacy coin-based payout machines are highly regarded for their reliability and sturdy construction. Many of these machines have modular designs that are easy to repair, and are still in very good working order with many years of reliable service remaining. As such, it would be desirable to have a simple and very cost effective means and method, which can be readily employed at the machine owner/operator's location—without having to send the machine to a remote location for modification.

Accordingly, what is most desirable is to have a simple low cost means and method that may be utilized by relatively unskilled individuals for converting a gaming machine from coin-based payouts to paper/receipt based payouts. It would further be desirable to enable this conversion and upgrade to be done with a minimal number of tools and modifications to the frame and structure of the gaming machine. Finally, it may be quite desirable to be able to convert the gaming machine back to coin-based payouts, with minimal inconvenience, at some future date, if for some reason that is desired.

A number of other characteristics, advantages, and or associated novel features of the present invention, will become clear from the description and figures provided herein. Attention is called to the fact, however, that the drawings are illustrative only. In particular, the embodiments included and described, have been chosen in order to best explain the principles, features, and characteristics of the invention, and its practical application, to thereby enable skilled persons to best utilize the invention and a wide variety of embodiments providable that are based on these principles, features, and characteristics. Accordingly, all equivalent variations possible are contemplated as being part of the invention, limited only by the scope of the appended claims.

### SUMMARY OF PREFERRED EMBODIMENTS

In accordance with the present invention, a method and apparatus enable a converting of a coin-based payout gaming machine to a paper-based (receipt) payout machine. Importantly, the most preferred methods and means of the invention teach the replacing of a typical or industry standard coin hopper module with a coin hopper conversion apparatus. The coin hopper conversion apparatus includes a coin hopper conversion module and a printer module. The coin hopper conversion module electrically simulates the operation of the standard coin hopper mechanism. That is, the coin hopper conversion module receives electrical signals meant for the coin hopper mechanism and provides appropriate responses to the gaming machine that are typically generated by the coin hopper module. As a result, the gaming machine and the original operational (programmed) functionality need not be modified when a preferred embodiment of the present invention is employed.

It may be further noted that the coin hopper conversion module of the invention may be configured for employing a standard interface (and the electro-mechanical portions thereof). For example, a standard 7-pin connector and slide mount have been employed with popular gaming machines, as a de-facto industry standard, for well over a decade. These structures enable a defective or problematic coin hopper mechanism to be quickly removed and replaced with a spare and properly functioning unit. This provides an easy to maintain and highly modular gaming machine. In the case of the present invention, by employing such an interface/connector for accessing the electrical signal(s) of interest, the modification of contemplated coin-based gaming machine requires no cutting and or splicing of wires. In addition, this conversion methodology enables an individual to rapidly convert the machine back to coin-based payouts—if ever needed.

A preferred embodiment of a first method of the invention calls for signals and pulses meant for activating and controlling the mechanical coin hopper to be received, counted, and or processed by the coin hopper conversion module, for determining a cash-out amount. This cash-out amount, which will also be termed total payout amount, must be determined in order to print and dispense a paper-based cashier receipt. One preferred input signal to the coin hopper conversion module is an “Enable-A” signal that is produced by the gaming machine when a payout to a player of the machine is needed. This signal is received by the coin hopper conversion module, and as a result, causes pulses of a possibly and or preferred reduced frequency, to be generated and provided to the coin hopper interface “coin-out” signal. Therefore the coin hopper conversion module is adapted for detecting a succession of input (enable) pulses, and generating a plurality of response (coin-out) pulses.

Based on the method of the invention employed, either input or output pulses of the coin hopper conversion module may be passed through to a printer mechanism. As such, for the above described embodiment, typically a plurality of Enable-A pulses or the response (coin-out) pulses, are coupled to and passed through to a printer mechanism, which counts the pulses and remotely (within the printer mechanism) determines a total payout amount.

In yet another preferred embodiment the coin hopper conversion module, a counting of a succession of pulses may be effected wherein each pulse causes an adding of a basic monetary increment to a total payout amount. Once all the pulses of this succession of pulses are counted, the coin hopper conversion module is employed for causing a printing of a redeemable cashier receipt from a printer mechanism coupled to the coin hopper conversion module. With this second embodiment, the printer mechanism is not counting pulses, but is arranged to receive information indicating the amount of the total payout amount, which results in the printing of a redeemable cashier receipt.

Another aspect of the invention, which may be employed with any of the above discussed methods of the invention or others discussed hereinafter, calls for the inclusion of a settable configuration value that is employed for determining a divide-by-N factor for enable input pulses to coin-out response pulses. For example, in one possible embodiment, the configuration value may be set so that for every 4 enable pulses received only one coin-out pulse is generated and returned to the gaming machine via the coin hopper interface. This feature is important for several reasons that will be fully discussed when referring to the timing diagrams of FIGS. 11A through 11C.

It is important to note that the preferred modification methods of the invention are low cost, simple, and modular. Accordingly, an industry standard and very modular coin-based gaming machine may quickly and efficiently be converted—at the owner/operator's location—using an approach that maintains the reliability and serviceability of the gaming machine, and its full modularity. As the preferred embodiments of the invention teach methods wherein the gaming machine software and coin hopper interface are not modified, the gaming machine may be converted to and from coin-based payouts, as needed.

### BRIEF DESCRIPTION OF THE DRAWINGS

In the drawings, like elements are assigned like reference numerals. The drawings are not necessarily to scale, with the emphasis instead placed upon the principles and features of the present invention. Additionally, each of the embodiments depicted are but one of a number of possible arrangements utilizing the fundamental concepts of the present invention. The drawings are briefly described as follows:

FIG. 1 illustrates a ubiquitous and well known legacy gaming machine that can be converted using embodiments of the present invention.

FIG. 2 depicts an interior of a lower portion of a coin-based gaming machine, revealed by a front access door being in the open position, with a coin hopper mechanism clearly in view.

FIG. 3 provides a closer view of a very modular and commonly employed coin hopper mechanism, which is easily and readily replaced by the preferred embodiments of the present invention.

FIG. 4 illustrates the interior of the gaming machines depicted in FIGS. 2 and 3, with the modular coin hopper mechanism now removed, exposing a hopper interface connector J1-S, which is included with many legacy gaming machines of interest.

FIGS. 5A and 5B provide depictions of an embodiment of the coin hopper conversion module of the invention, as viewed from a first side and a second side, respectively, while clearly showing possible embodiments of J1-P and J2.

FIG. 6 illustrates an interior consistent with FIG. 4, with the coin hopper conversion module now installed within the location previously occupied by the original (modular) coin hopper mechanism.

FIG. 7 shows the coin hopper conversion module of FIG. 6 along with a face plate of a preferred printer module installed in a base portion supporting the gaming machine, with the printer module arranged to provide printed paper-based cashier receipts.

FIG. 8 provides a simplified and conceptual high-level block diagram of the prior art gaming machine consistent with the legacy machine depicted in FIGS. 1 to 4, wherein an electro-mechanical gaming machine portion is coupled to a coin hopper mechanism by way of a standard interface and connector.

FIG. 9 provides a simplified high-level block diagram of a now modified prior art gaming machine, consistent with the depictions of FIGS. 1 to 7, clearly depicting a gaming machine portion coupled to a coin hopper conversion apparatus, which includes a coin hopper conversion module and a printer module of the invention.

FIG. 10A provides a more detailed high-level block diagram consistent with the embodiment of FIG. 9, depicting a first group of possible operative tasks and or functions that may be employed with an embodiment of the coin hopper conversion module/apparatus of the invention.

FIG. 10B provides an alternate detailed high-level block diagram consistent with yet another preferred embodiment of the coin hopper conversion module, wherein a second group of possible operative tasks and or functions is shown.

FIGS. 11A, 11B, and 11C depict representative and simplified timing diagrams for a modular coin hopper mechanism (FIG. 11A), along with a first operative embodiment (FIG. 11B) and a second/alternate operative embodiment (FIG. 11C) of the present invention.

FIGS. 12A and 12B provide exemplary configuration tables that may define operational settings of a configuration switch, or equivalent jumpers, to determine a rate of payout for a coin hopper conversion apparatus of the invention.

### PARTIAL LIST OF REFERENCE NUMERALS

20—coin hopper conversion apparatus

30—coin hopper conversion module (of 20)

30a—housing (of 30)

32a,32b—functions

34a,34b—(alternate) functions

36—configuration means (of 30)

40—printer module (of 20)

42—paper receipt dispensing opening

70—printer interface signals

72—printer interface cable

80—power input cable

100—(legacy) gaming machine

102—upper portion (of 100)

104—lower portion (of 100)

104a—slot reels

104b—player buttons/input

105—lower interior (of 104)

108—player pull handle

110—coin tray

112—electronics motherboard assembly

112a—upper edge or side (of 112)

120—hopper interface signals

200—coin hopper mechanism

202—coin holding hopper bin

204—hopper motor

206—hopper pull handle

210—coin drop box opening

218—cable feed-thru cutout

240a—first (base) portion of slide mount

240b—second (hopper) portion of slide mount

300—gaming machine base

J1—hopper interface connector

J1-P—hopper interface plug of J1

J1-S—hopper interface socket of J1

J2—printer interface connector

### DETAILED DESCRIPTION OF EMBODIMENTS OF THE INVENTION

It is important to establish the definition of a number of descriptive terms and expressions that will be used throughout this disclosure. The term ‘gaming machine’ is to be broadly defined and may include any gaming or gambling apparatus that accepts coins, bills, vouchers, etc., and provides for coin-based payouts as a primary means of providing payouts to users (players) of the gaming machine. As such, gaming machines of the invention may certainly include slot machines, video poker machines, multi-game machines, and other electronic games of chance. The term ‘cashier receipt’ may be considered an equivalent of terms such as a ‘cash slip’, ‘cashier slip’, ‘paper receipt’, ‘printed receipt’, and other similar terms. In each case the receipt/slip represents a total payout amount that can typically be redeemed for cash. The term ‘interface’, as employed for example when discussing the coin hopper interface, may be assumed to indicate an electrical portion of a gaming machine useful for coupling the coin hopper conversion module of the invention into the gaming machine. Further, based on the context in which it is employed, the term interface may be extended to cover both the electrical (electro) and the mechanical portions of industry standard electro-mechanical coin hopper interfaces. The most preferred embodiments of the coin hopper conversion module are intended to be fully compatible with such industry standard interface means, enabling direct connection to existing/legacy connectors intended for use with coin hopper mechanisms, as well as the coin hopper conversion module. Similarly, the term ‘electrical signal’, as employed for example when describing the hopper interface of the gaming machine, may include at least one output signal and at least one input signal, most preferably of a digital type, that is coupled by way of direct mechanical, magnetic, and or optical signal coupling techniques that are well known to skilled persons. The terms ‘payout increment’, ‘payout constant’, and ‘monetary payout increment’ are to be defined as a fundamental payout unit, which may be used during an add and accumulate process, and employed for ultimately determining a total payout amount. For example, if the monetary payout increment was a nickel, and a payout of $1.10 is required, a value of $0.05 would be repeatedly added (via an add-accumulate activity) until a total of $1.10 was achieved. Typically once the total payout amount is determined, the value is employed to cause a cashier receipt to be printed and dispensed to a player of the gaming machine.

Continuing, the terms ‘coupler’, ‘coupled to’, ‘coupling’, etc., are to be understood to mean that two or more described items are either directly connected together, or alternately, connected to each other via one or more additional, possibly implied or inherent structures or components. For example, when considering the coupling of a printer module to the coin hopper conversion module, such a coupling may be via a cable (preferred) or by way of an isolating coupling such as a magnetic or optical interface means. Other important terms and definitions will be provided, as they are needed, to properly define the present invention and its associated novel characteristics and features. In addition, the terms and expressions employed herein have been selected in an attempt to provide a full and complete description of the invention. These terms may very well have equivalents known to skilled individuals, which may be long established in the art. As such, the terminology employed has been carefully chosen and is intended for illustration and completeness of description, and may very well have equivalents that are known in the art, but not employed here.

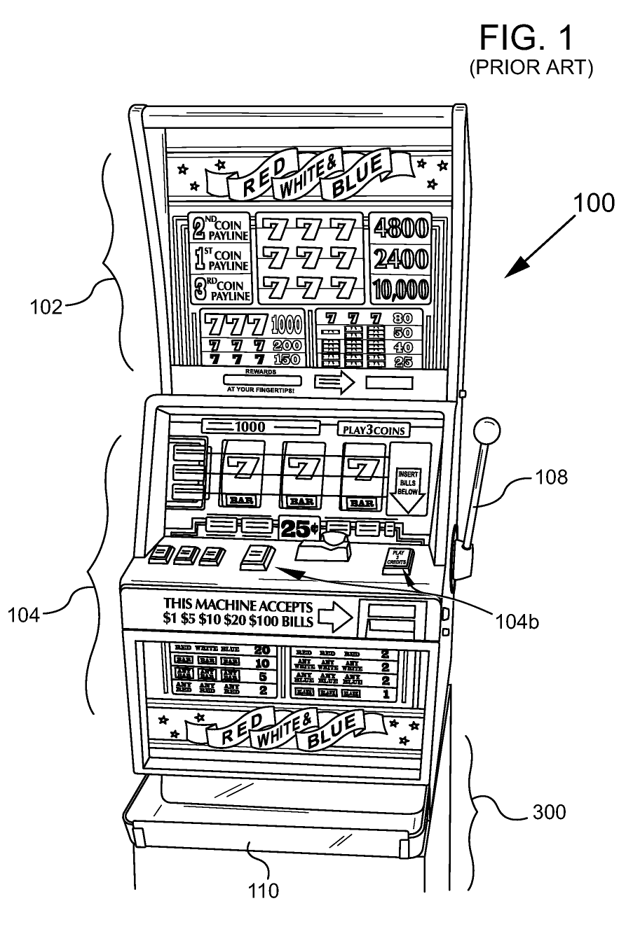

Referring now to the drawings, FIG. 1 depicts a well known legacy gaming machine that may be readily converted to paper-based payouts using embodiments of the present invention. As shown, the gaming machine 100 includes an upper display portion 102, a lower portion 104, and a coin tray 110. Often the lower portion 104 of the gaming machine 100 includes an access door, which in FIG. 1 is shown in the closed position. As also shown in FIG. 1, lower portion 104 includes player inputs such as buttons 104b and a player pull handle 108.

In addition to the gaming machine 100, FIG. 1 also depicts a base 300, which is often made of wood or a composite material. The base 300 is employed to support the gaming machine at a desired height, while housing a coin drop box (not explicitly shown but well known to skilled individuals). When considering the present invention, the base 300 will be modified to accept and support a printer module of the coin hopper conversion apparatus.

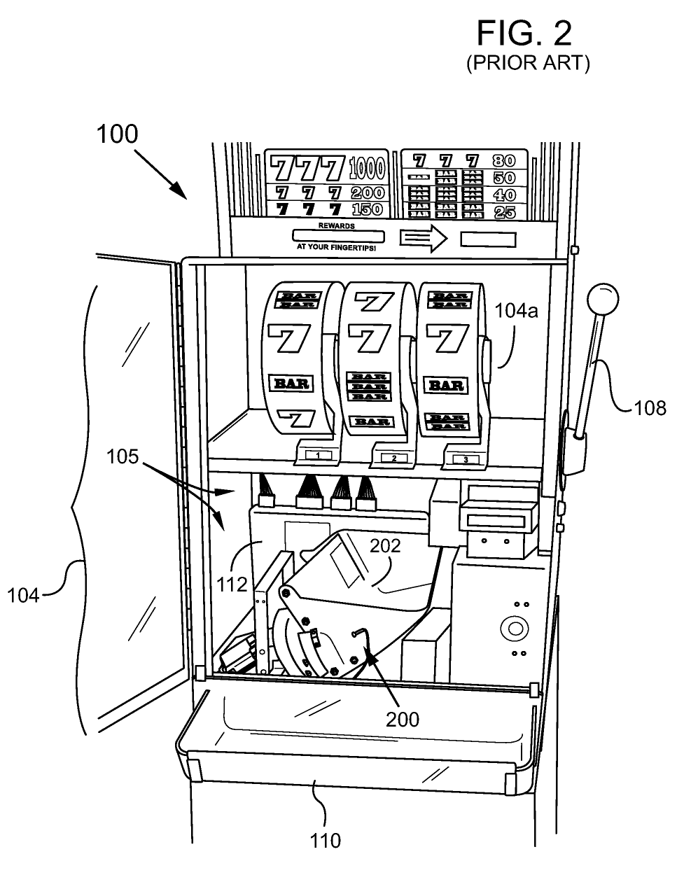

Turning now to FIG. 2, the gaming machine of FIG. 1 is now depicted with a front access door in the open position, and clearly showing a lower interior 105 of the lower portion 104 of the gaming machine 100. As illustrated the lower portion 104 includes an upper interior for housing the slot reels 104a, and a lower interior 105 of the lower portion 104, which houses items that may be generally termed electro-mechanical components and or electronic modules and assemblies of the gaming machine 100. For example, as illustrated in FIG. 2, the lower interior 105 of the depicted gaming machine includes an electronics motherboard assembly 112 and a coin hopper mechanism 200. As understood by skilled repair persons, the depicted gaming machine 100 is quite modular, supporting quick servicing with few or no tools required. For example, for the gaming machine 100 of FIGS. 1 and 2, when the front access door is moved into the fully open position (as shown in FIG. 2), items such as the coin tray 110 may simply be lifted off, and the coin hopper mechanism 200 may simply be pulled and slid out (effecting an unplugging of the coin hopper from a coin hopper (electrical) interface of the gaming machine 100.

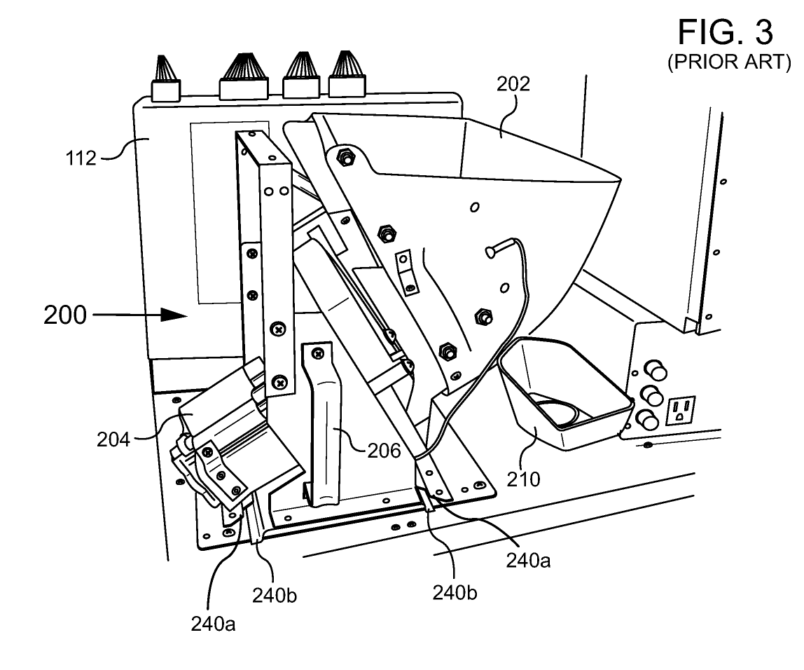

Referring now to FIG. 3, a more detailed and close-up view of a commonly employed coin hopper mechanism 200 is shown having a hopper motor 204 which is activated to cause coins held in the coin holding hopper bin 202 to be slowly dispensed. As will be discussed hereinafter, the hopper motor 204 has associated therewith an enable signal. For example, in one possible operational embodiment, it may be assumed that when the hopper motor 204 is activated, pulses will be provided upon an enable signal that will be designated Enable-A. Further shown in FIG. 3 is a hopper pull handle 206, which can be firmly grasped and pulled to cause the coin hopper mechanism 200 to slide forward, enabling removal of the coin hopper mechanism 200 from the lower interior 105 of the gaming machine 100. Specifically supporting this quick and easy removal of the coin hopper mechanism is a first portion of a slide mount 240a that is fixed to the coin hopper mechanism 200, while a mating second portion 240b is fixed to the gaming machine 100. When an individual grasps and pulls firmly upon the pull handle 206, the coin hopper mechanism 200 slides out of the slide mount 240a/240b and may be fully removed—without the need to cut any wires or use any tools.

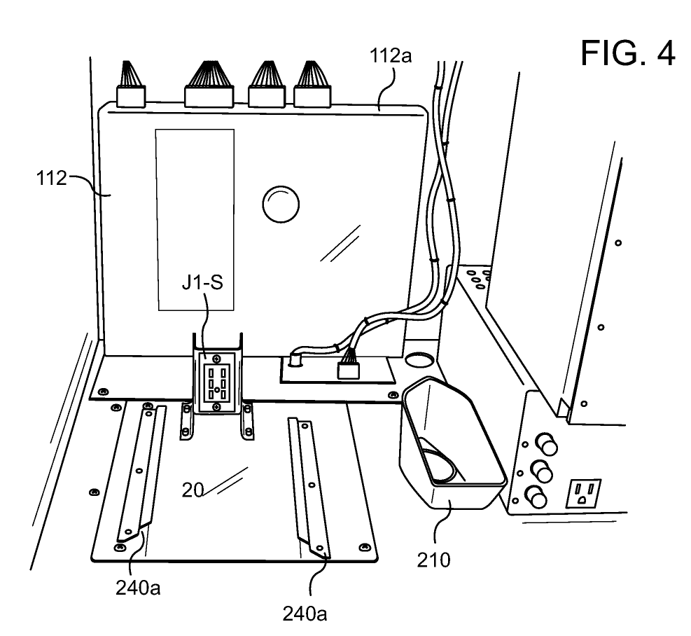

Once the coin hopper mechanism 200 has been removed, as illustrated in FIG. 4, the lower interior 105 of the gaming machine 100 is quite open, and access is now possible to the gaming machine coin hopper interface. For the example depicted in FIG. 4, the coin hopper interface is easily and readily accessed by way of a hopper interface connector portion, termed the hopper interface socket J1-S. Also clearly shown in FIG. 4 is the electronics motherboard assembly 112, an upper connector edge 112a of the board assembly 112, and the coin drop box opening 210.

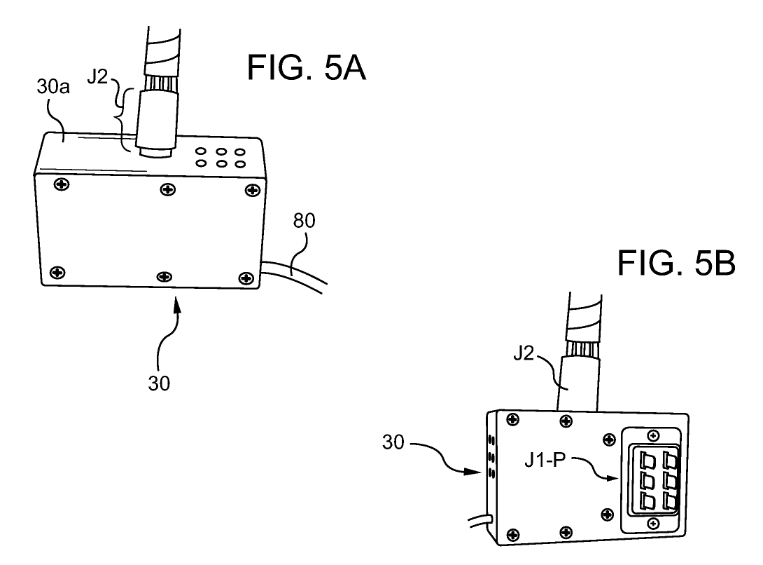

Turning to FIGS. 5A and 5B, an embodiment of a coin hopper conversion module 30 of the invention is depicted as viewed from a first side (FIG. 5A) and a second side (FIG. 5B). As shown, the coin hopper conversion module 30 includes a housing 30a, which as shown in FIG. 5B supports a portion of a hopper interface connector J1-P and a printer interface connector J2. Further depicted is a power input cable 80, which is employed when power for the coin hopper conversion module 30 is not drawn directly from the hopper interface. Importantly, with the embodiment of the coin hopper conversion module 30 illustrated, a hopper interface plug J1-P is included that extends outwardly from the housing 30a, and is intended to be plugged into the hopper interface socket J1-S (shown in FIGS. 4, 6, and 7 through 10B). The plugging of the plug J1-P into the hopper interface socket J1-S causes a coupling to and an accessing of a plurality of electrical signals of the coin hopper interface.

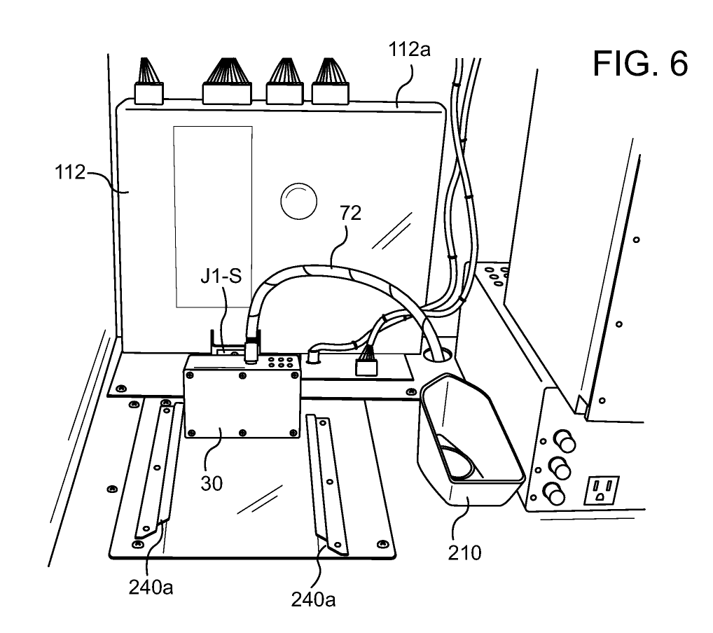

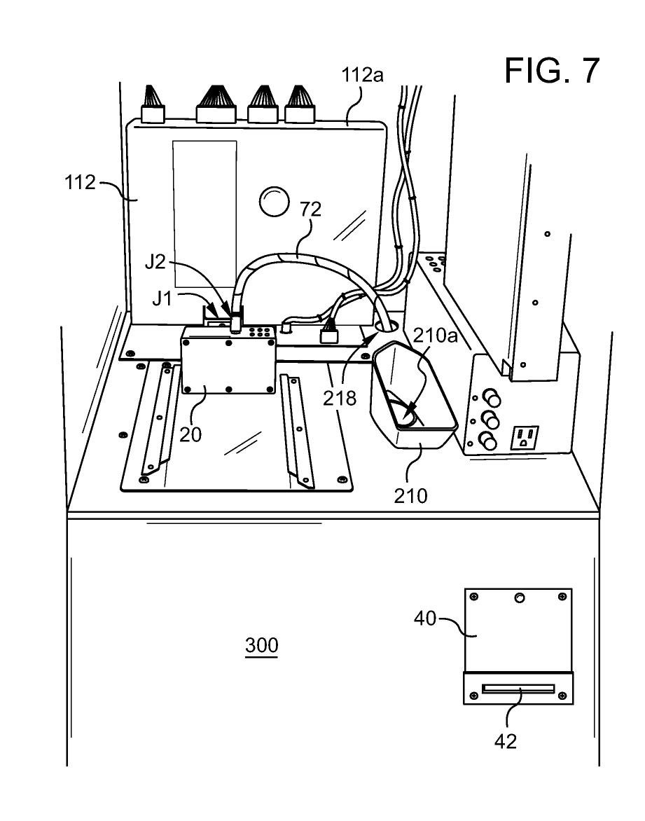

Accordingly, as shown in FIGS. 6 and 7, once the coin hopper mechanism 200 is removed, providing access to the coin hopper interface, the hopper interface plug J1-P of the coin hopper conversion module 30 may be plugged into the hopper interface socket J1-S, causing a coupling of the coin hopper conversion module 30 to the coin hopper interface and thereby enabling a sensing and processing of the electrical signals of the interface. Importantly, such processing will include a detecting of at least one of signal changes and signal events of at least one electrical signal of the interface with the goal of determining a total payout amount. As skilled persons will appreciate, the structure and socket-plug approach employed for coupling to the coin hopper interface removes the need for cutting of and or slicing to wires of the interface. In addition, this highly modular approach supports a backward conversion, wherein the coin hopper mechanism 200 may be re-installed, if a need to do so ever arises.

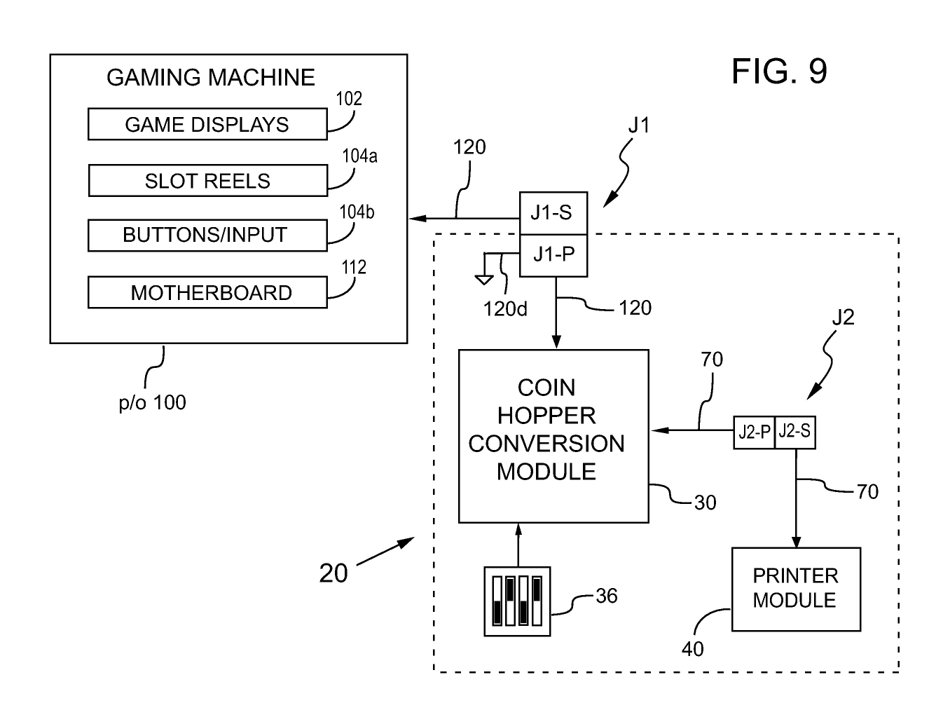

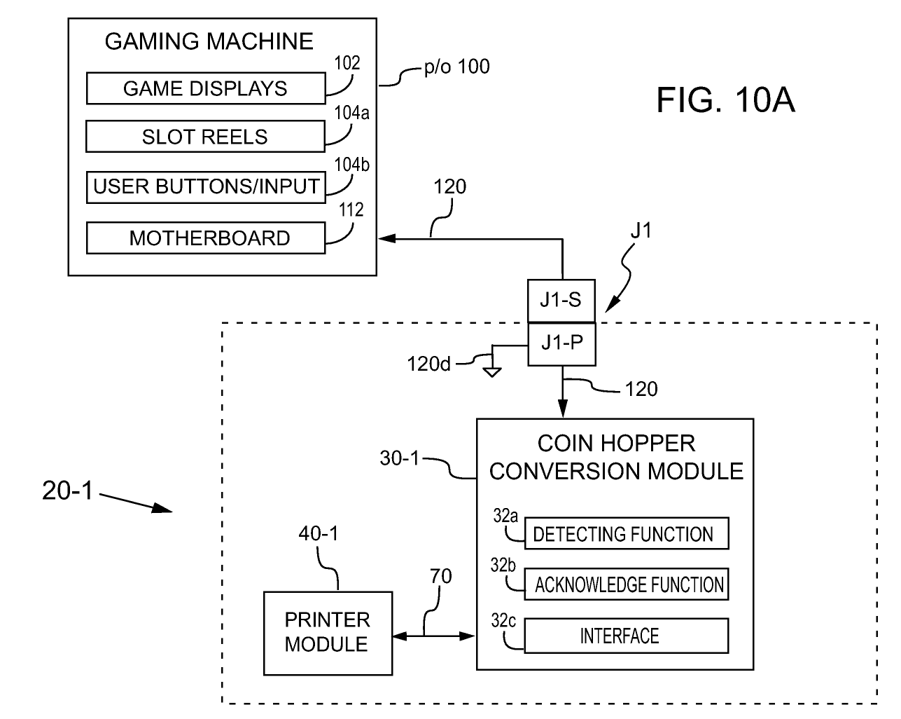

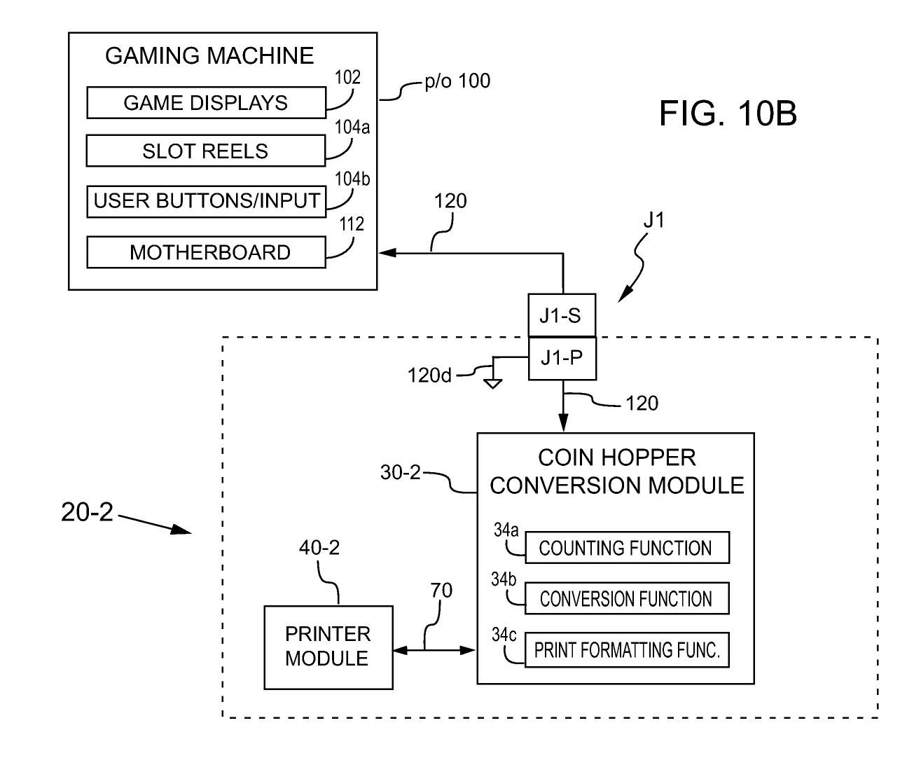

Returning to FIGS. 6 and 7, once the coin hopper conversion module 30 is installed within the lower interior 105 of the lower portion 104, and a printer module 40 is installed in the base 300, a plurality of printer interface signals 70 (see FIGS. 9, 10A, and 10B) of the coin hopper conversion module 30 may be coupled to the printer module 40 using a simple printer interface cable 72. For the example shown in FIG. 7, a simple cable feed-thru cutout 218 may be employed for routing the printer interface cable 72 between the coin hopper conversion module 30 and the printer module 40.

As shown in FIG. 7, and as will be further discussed hereinafter, a base 300 modification may be affected by installing a generalized printer module 40, such that a printed cashier receipt (not shown) may be printed and dispensed through a face plate and an included paper receipt dispensing opening 42. As can be seen in FIG. 7, a preferred location for the paper receipt dispensing opening 42 may be upon a front facing surface of the base 300. Alternately, and possibly with greater mechanical modification, a suitable printer module 40 may be located in another convenient location upon either the housing of the gaming machine 100, the base 300, or another possible providable or available structure/housing.

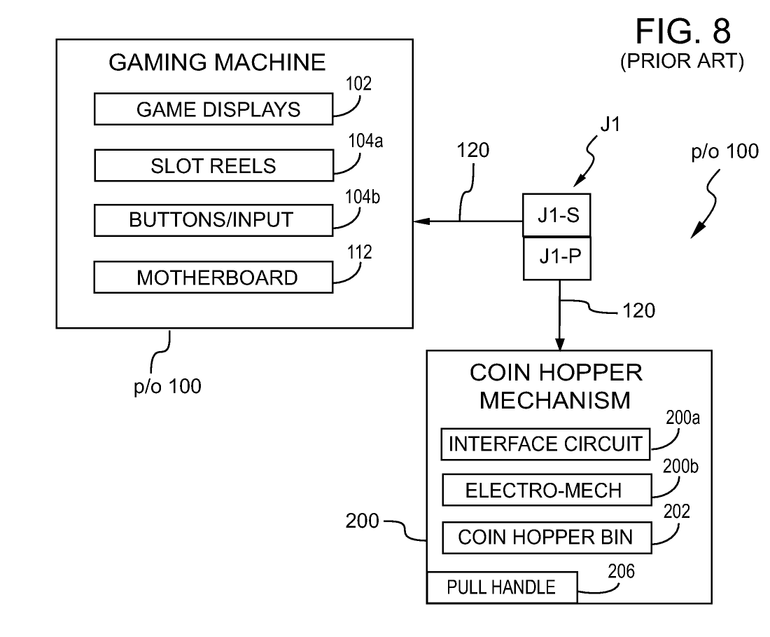

In order to better understand a number of preferred operational and functional embodiments of the coin hopper conversion module 30, attention will now be turned to FIGS. 8, 9, 10A, and 10B. As shown in FIG. 8, a simplified and conceptual high-level block diagram of a legacy prior art gaming machine is provided that is consistent with the gaming machine 100 depicted in FIGS. 1 to 4. As shown, an electro-mechanical gaming machine portion, designated p/o 100, includes a game display of upper portion 102, a plurality of slot reels 104a, player buttons/inputs 104b, and an electronics motherboard assembly 112. Another important component of the gaming machine 100 is the coin hopper mechanism 200. Common coin hopper mechanisms 200 include an electronic interface circuit 200a and an electro-mechanical portion 200b, which includes a coin dispensing means (not shown in FIG. 8) that causes coins contained in the coin holding hopper bin 202 to be dispensed during cash-out activities. As understood by skilled persons, and as discussed hereinabove, a simple and de-facto industry standard interface is also depicted, which typically includes a socket portion (J1-S) of the gaming machine 100 and a plug portion (J1-P) of the modular coin hopper mechanism 200. It should be noted that other portions of the gaming machine, such as the bill acceptor mechanism and internal power supply modules, have been omitted so as to not obfuscate the germane discussions related to the present invention.

Turning now to FIG. 9, a now modified gaming machine 100 is depicted by way of a simplified high-level block diagram. For the example of FIG. 9, a preferred modification method involves a removing (unplugging) of the coin hopper mechanism 200 and an installing of a coin hopper conversion apparatus 20. As clearly shown in FIG. 9, preferred embodiments of the coin hopper conversion apparatus 20 includes the coin hopper conversion module 30 and the printer module 40. To maintain the modular design of the original gaming machine 100, the interfacing of the coin hopper conversion module 30 and the printer module 40 utilizes a modular approach that includes an added connector J2, which includes a plug portion J2-P and a socket portion J2-S. While several preferred operational and functional embodiments will be discussed in FIGS. 10A and 10B, skilled individuals will appreciate that the coin hopper conversion module 30 may be provided by many available and substantially off-the-shelf technology solutions. These include microprocessor and or microcomputer based solutions (either single chip or board based), configurable device solutions such as field programmable gate arrays (FPGAs), programmable logic controllers (PLCs), etc.

Turning now to FIG. 10A, a first possibly preferred functional embodiment of the present invention will be discussed. As depicted in FIG. 10A, a contemplated implementation of a coin hopper conversion module 30-1 may include a detecting function 32a and an acknowledge function 32b. In addition, an interface capability and function is needed for coupling information (e.g., pulses, data, etc.) to the included printer module 40-1. The detecting function 32a, or similar/equivalent function, is included for detecting and processing one or more of the electrical signals of the coin hopper interface. Although the detecting of these signals may involve at least one of detecting signal changes and or detecting signal events such as signal level changes, for the examples that will be fully discussed herein, the detecting will involve detecting and processing pulses of a succession or stream of pulses of a somewhat short relative duration, as opposed to one level change that is maintained for a sufficient ‘pay-out’ duration. This former approach will be utilized as it is compatible with many legacy gaming machines of interest, and provides a solution wherein the original functional programmed operation of the gaming machine need not be altered, updated, or generally modified in any way. However, for other legacy gaming machines, and in situations wherein a modification of the original functional programmed operation of the gaming machine is desirable or acceptable, other detecting and processing methods and approaches may certainly be utilized.

Returning to FIG. 10A, the detecting of pulses of the succession of pulses indicates the start of what may be termed a payout cycle. That is, a player has decided to cash-out and there is a need for determining a total payout amount. For an unmodified gaming machine, the succession of pulses causes an activating of the hopper motor 204 and an agitator, which causes a dispensing of coins held within the hopper bin 202 (depicted in FIGS. 2 and 3). Importantly, once the coin hopper conversion module 30-1 is installed, and the pulses are detected, the coin hopper conversion module 30-1 must generate representative and corresponding acknowledge pulses. The generation of acknowledge pulses may be provided for by the acknowledge function 32b. As understood by skilled persons, in general, each acknowledge pulse represents a dispensing of a coin. Further, each pulse causes the electronics motherboard of the gaming machine 100 to decrement a count of the coins left to be dispensed. Once the total number of acknowledge pulses have been received by the motherboard assembly 112, the pulses of the succession of pulses is halted.

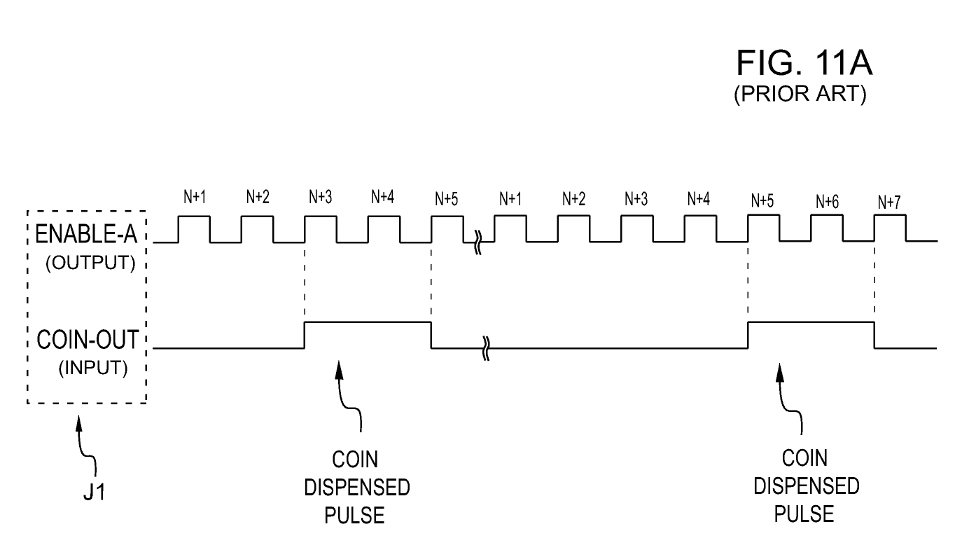

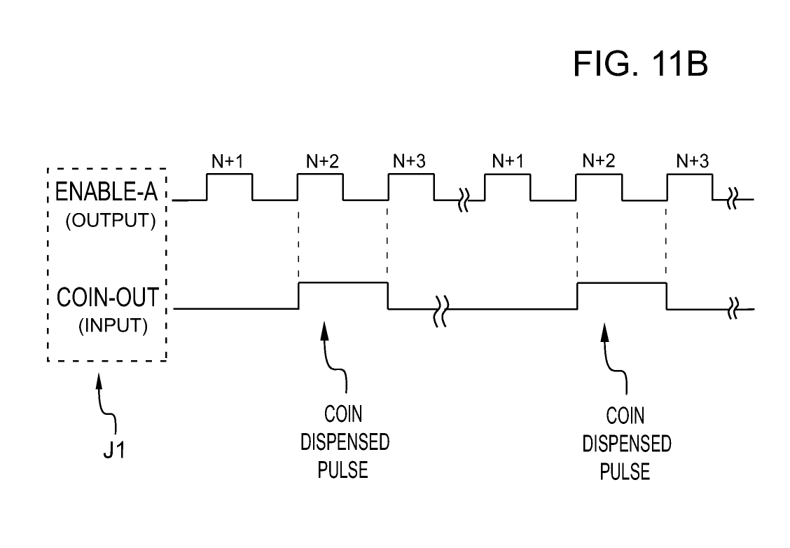

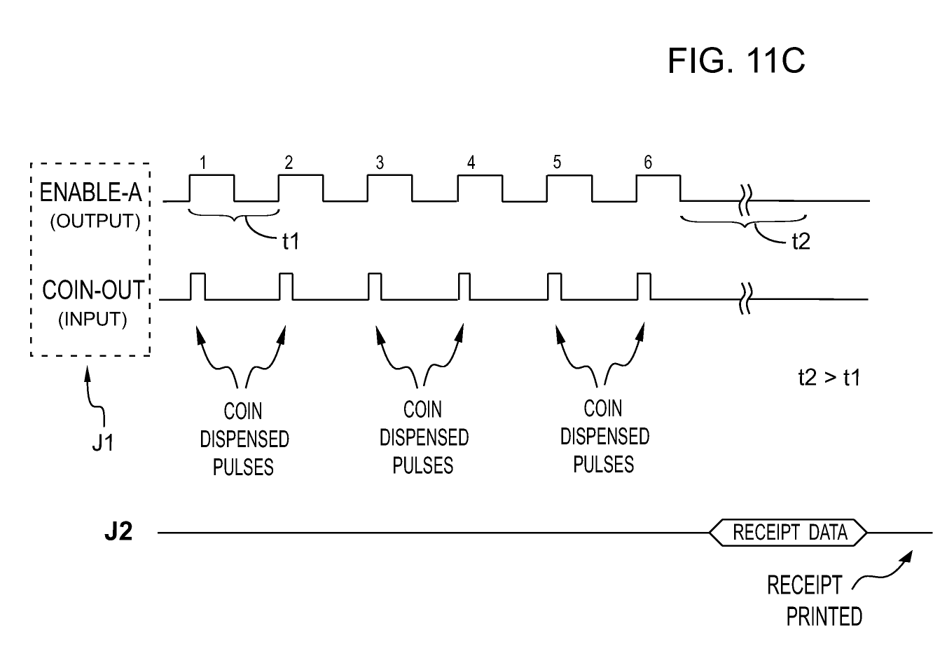

For the embodiment of the invention of FIG. 10A, the interface function 32c is a simple embodiment wherein the acknowledge pulses are also passed along to the printer module. As each of the acknowledge pulses represents a monetary payout increment, which must be totaled to determine the full amount of a total payout amount, the printer module 40-1 must be configured or programmed for a specific monetary payout increment. For example, for a nickel machine, the monetary payout increment would be 0.05 dollars. For a quarter machine, the monetary payout increment would be 0.25 dollars. For the embodiment of FIG. 10A, the adding and accumulating of acknowledge pulses is effected by the printer module 40-1. It should also be noted, as will be discussed hereinafter when referring to FIGS. 11A through 11C, that the number of pulses required to generate each acknowledge pulse may be variable in an unmodified coin hopper based gaming machine. For a modified gaming machine, wherein a coin hopper conversion module 30-1 has been installed, it may be preferable to be able to select and configure the number of pulses received before an acknowledge pulse is generated. Further, a timeout period may be employed by the coin hopper conversion module 30-1, wherein once pulses are no longer being received, the printing and dispensing of the paper cashier receipt may commence.

Turning now to FIG. 10B, an alternate detailed high-level block diagram of yet another preferred embodiment of the coin hopper conversion apparatus 20 is defined by way of a possibly preferred second set of alternate operative tasks and or functions. As shown, a coin hopper conversion module 30-2 may include a counting function 34a, a conversion function 34b, and a print formatting function 34c. Importantly, as with the first described coin hopper conversion module 30-1 the detecting of pulses of the succession of pulses is still required, and again results in a generating of a representative or proportionate number of acknowledge pulses. These activities are stilled needed to mimic the operation of the original coin hopper mechanism 200. It may be noted that the expression ‘proportionate number of acknowledge pulses’ indicates that a pre-determined number of pulses of the succession of pulses must occur (be detected and counted) before a corresponding resulting acknowledge pulse is generated. Further, the acknowledge pulses of the coin hopper conversion module 30-2 are not passed along to the printer module as they are generated. Instead a counting function 34a totals the acknowledge pulses until the succession of pulses is halted—indicating that the needed number of acknowledge pulses for a total payout amount has been received by the electronics motherboard assembly 112 of the modified gaming machine 100. At that point the resulting (total) count of acknowledge pulses may be processed by the conversion function 34b to determine the total payout amount. For example, consider a payout cycle wherein the gaming machine is a half-dollar machine. That is, for each acknowledge pulse generated it is assumed that a half-dollar coin is dispensed. Further assume that the count of acknowledge pulses determined is ‘27’. Then the processing required, which is provided at least in part by the conversion function 34b, will include a multiplication process (or an equivalent repeated addition based algorithm) wherein the count of ‘27’ is multiplied by $0.50 to determine a total payout amount of $13.50—which may then be printed on a cash receipt. In order to communicate the total payout amount to the printer 40-2, a print formatting function 34c may be employed. For example the print formatting function 34c may be employed to convert the determined total payout amount (e.g., $13.50) to the needed data format (e.g., extended ASCII format) and communicated by way of the printer interface signals 70 to the printer module 40-2 for causing a printing and dispensing of the needed cashier receipt.

Turning now to FIGS. 11A through 11C, several simplified and representative timing diagrams will be briefly discussed to further define the function of an available enable signal (e.g., the Enable-A signal) and an available acknowledge signal (e.g., the Coin-out signal). As shown in FIG. 11A, a legacy gaming machine 100 that dispenses coins from a coin hopper mechanism, begins dispensing coins by activating the Enable-A signal. For the gaming machine of the present discussion, the activating of the Enable-A signal produces a succession of pulses, which are coupled to the coin hopper mechanism 200. Once the succession of Enable-A pulses causes the hopper motor 204 and an agitator of the coin hopper mechanism 200 to activate, it typically requires a plurality of these enable signal pulses for an actual coin to be dispensed by the coin hopper mechanism 200. As understood by skilled persons, the actual number of Enable-A pulses required for each coin to be dispensed may vary, essentially due to the mechanical nature and characteristics of the coin hopper mechanism 200. As such, the leading edge of the first Coin-out pulse depicted in FIG. 11A is shown associated with at least N+3 Enable-A pulses. As also shown, the second Coin-out pulse required at least N+5 Enable-A pulses before becoming active or asserted. Recall also that each Coin-out acknowledge pulse indicates that a coin has been dispensed from the hopper and provided to a player. Accordingly, if N was assumed to be 10, then the first coin is dispensed at 13 pulses and the second coin is dispensed at 15 pulses.

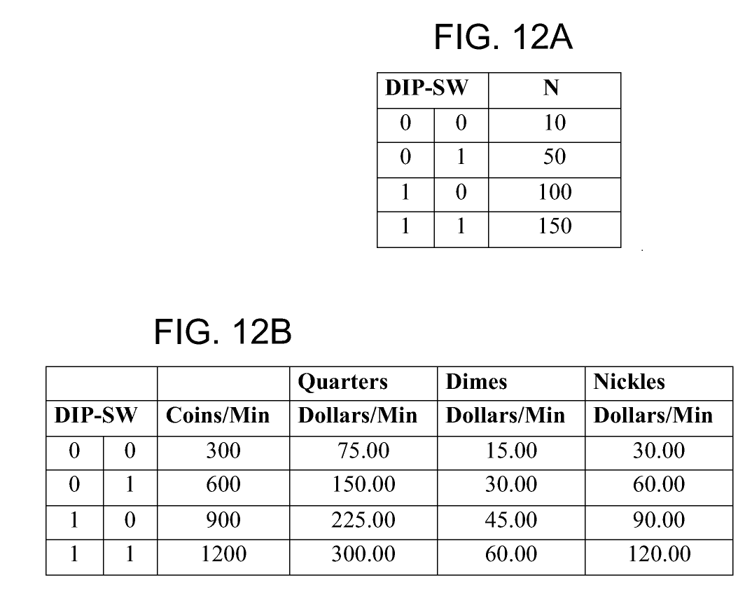

It may be noted that relationship of Enable-A pulses to Coin-out pulses associated with the timing diagrams of the coin hopper conversion module 30, 30-1, and 30-2, of the present invention will typically be much more deterministic, and possibly configurable (e.g., end user settable). For example, as clearly shown in FIG. 11B, the coin hopper conversion module may be configured to generate a Coin-out acknowledge pulse during each N+2 detected and processed Enable-A pulses. As such, the coin hopper conversion module 30 may operate as a divide-by-N type counter, providing a frequency reducing function (if advantageous or needed). In addition, it may certainly be desirable to be able to set or alter the actual divide-by-N value employed. For example, as shown in FIG. 9, the coin hopper conversion module 20 may include a settable configuration means 36, depicted as a simple 4-bit DIP switch. The configuration means 36 may enable an individual to alter the divide-by-N value. For example consider a 2-bit configuration value, which may be established using a low cost DIP switch or shorting jumper arrangement. As shown in FIG. 12, by employing a two bit configuration value, the value of N may be set to either 10, 50, 100, or 150. That is, if the divide-by-N value of approximately 10 is desired, a configuration value of ‘00’ would be provided. With this configuration value the coin hopper conversion module 30 would then need to detect/process 10 pulses in order for an acknowledge (e.g., Coin-out) pulse to be generated. Should the divide-by-N value of 10 prove to be too fast for the circuitry of the electronic motherboard assembly 112, then a higher divide-by-N configuration value may be employed. As appreciated by skilled persons, the reading of settings such as a divide-by-N configuration value would typically happen upon the powering up of the gaming machine 100—if such a feature is included.

It may be noted that a configuration means (or value) may be defined in terms of a ‘coins-per-minute’ value. For example, as can be seen in FIG. 12B, a configuration value may define the number of acknowledge pulses (coins) that occur each minute. For example, if the configuration value is set to ‘10’, then the coin per minute rate would be 900, which would provide a payout per minute rate based on the monetary payout increment being employed.

Similarly, a configuration setting or value may be employed for indicating the value of the monetary payout increment, which may also be termed a payout constant and a multiplication constant. The monetary payout increment must typically be matched to the gaming machine into which the coin hopper conversion module has been being installed. That is, the monetary payout increment may be set based on whether the machine takes nickels, quarters, half-dollars, etc.

It may further be noted that legacy gaming machines 100 may or may not be able to process Coin-out pulses that are as narrow as those depicted in the timing diagrams FIGS. 11A and 11B. Further, legacy gaming machines that employ the original and unaltered operative functional programming may not be able to operate at the maximum cash-out rate, as depicted in FIG. 11C. As shown in FIG. 11C, for each detected Enable-A pulse, a Coin-out pulse is provided, either of which may be counted and totaled—due to their one-to-one relationship. Once a period of inactivity is detected for the Enable-A signal, say upon an expiring of a pre-defined or pre-selected timeout interval t2, the total count may be employed with a monetary payout increment value, for determining a total payout amount. It may be noted that when considering an embodiment wherein pulse counting and processing occurs within the printer module 40-1, the pre-selected timeout interval t2 may be detected by the printer module 40-1. Alternately, and as depicted in FIG. 11C, the timeout interval t2 would be determined by the coin hopper conversion module 30-2, with receipt data (as shown in FIG. 11C) communicated to the printer module 40-2, causing a cashier receipt to be printed.

As understood by skilled persons, a suitable timeout interval may be related to the frequency of the Enable-A signal. For example, assume the coin hopper conversion module 40-2 is implemented using a simple single-chip microcomputer that can be configured to count time intervals. The total period t1 may than be readily measured. Should an edge not be detected upon the Enable-A interface signal, say for an interval t2 that is greater than one full period t1, then it may be assumed that the full number of Coin-out pulses has been provided to the electronics motherboard assembly 112, and the determined count may be processed to determine the total payout amount and effect a printing of the cashier receipt.

Returning again to FIGS. 9, 10A, and 10B, each embodiment of the coin hopper conversion module 30 may be configured such that a diverter signal 120d of the hopper interface may be set (forced) to a continually active state. Should a player input coins to the gaming machine, which would normally be collected in the now removed coin holding hopper bin 202, the activated diverter mechanism will cause any coins input to the gaming machine to be diverted to the coin drop box (typically contained in the base 300). Accordingly, a diverter signal 120d of the hopper interface signals must be continually activated (e.g., grounded) for causing all coins input into the gaming machine 100 to be diverted to the drop box. The forcing of the diverter signal 102d, as depicted, is realized by connecting the diverter signal 120d to signal or chassis ground. This is readily realized by simply connecting the appropriate pin of the interface plug connector J1-P to ground.

While there have been described herein a plurality of the currently preferred embodiments of the means and methods of the present invention, those skilled in the art will recognize that other and further modifications may be made without departing from the invention. As such, the foregoing descriptions of the specific embodiments of the present invention have been provided for the purposes of illustration, description, and enablement. They are not intended to be exhaustive or to limit the invention to the specific forms disclosed and or illustrated. Obviously numerous modifications and alterations are possible in light of the above teachings, and it is fully intended to claim all modifications and variations that fall within the scope of the appended claims provided hereinafter.

1-10. (canceled)

11. A method for modifying a gaming machine originally structured with a modular coin hopper mechanism for dispensing coin-based payouts using coins held in the hopper mechanism, with the method causing a conversion from coin-based payouts to payouts resulting in a printing and dispensing of a paper-based cashier receipt to a player upon a cash-out request, instead of the original coin-based payout, the method of modifying the gaming machine including:
a) gaining access to and removing the modular coin hopper mechanism from an interior of the gaming machine, with the removing of the modular coin hopper mechanism resulting in a disconnecting of the hopper mechanism from the gaming machine and a hopper interface thereof, thereby providing access to a plurality of electrical signals of the hopper interface;
b) coupling to and employing the hopper interface and the electrical signals thereof for interfacing a coin hopper conversion apparatus, with the coin hopper conversion apparatus configured for:
i) detecting a succession of signal pulses, provided upon at least one electrical signal of the hopper interface;
ii) processing the detected signal pulses in order to generate an acknowledge signal for every pre-determined plurality of detected signal pulses of the succession of pulses;
iii) counting the acknowledge pulses and determining a total payout amount of a pending required paper-based payout;
c) printing and dispensing a cashier receipt for the determined total payout amount.

12. The method in accordance with claim 11, wherein the printing of the cashier receipt occurs upon a detecting of a timeout interval, during which the electrical signal employed for detecting pulses of the succession of pulses is not active.

13. The method in accordance with claim 11, wherein the step of counting the acknowledge pulses and determining the total payout amount is realized by one of:
a) the coin hopper conversion module, with the total payout amount communicated to a printer module coupled to the coin hopper conversion module; and
b) the printer module, wherein each generated acknowledge pulse is coupled to the printer module for counting thereby.

14 The method in accordance with claim 11, wherein the step of coupling to and employing the hopper interface involves plugging the coin hopper conversion module into a standard socket connector which originally electrically coupled the coin hopper mechanism to the gaming machine.

15-25. (canceled)
